(19) United States
(12) Patent Application Publication
(10) Pub. No.: US 2016/0302114 A1
(43) Pub. Date: Oct. 13, 2016

(54) SHARING MEASUREMENT RESOURCES WITHIN MULTI-RECEIVE MULTI-SIM USER EQUIPMENT

(71) Applicant: QUALCOMM Incorporated, San Diego, CA (US)

(72) Inventors: Sachin JAIN, Santa Clara, CA (US); Jin-Sheng SU, San Diego, CA (US); Tom CHIN, San Diego, CA (US)

(21) Appl. No.: 14/732,521

(22) Filed: Jun. 5, 2015

Related U.S. Application Data
(60) Provisional application No. 62/146,168, filed on Apr. 10, 2015.

(51) Int. Cl. H04W 36/00; H04B 1/3816; H04W 36/30; H04W 24/10

(52) U.S. Cl. CPC H04W 36/0083; H04W 36/0088; H04W 24/10; H04B 1/3816; H04W 36/30

(57) ABSTRACT

For a multi-receive multi-subscriber identity module (SIM) UE, one SIM or subscription may help with measurements of another SIM or subscription to help address the issue of large latency caused by insufficient measurement gaps. A method of wireless communication at a user equipment with a first subscription and a second subscription includes forwarding a neighbor cell list from the first subscription to the second subscription when preparing for measurement. The method also includes performing, by the second subscription, measurements of neighbors from the neighbor cell list. The method further includes forwarding the measurements of neighbors from the neighbor cell list, from the second subscription, to the first subscription. The first subscription may measure a portion of the neighbors from the neighbor list while the second subscription measures another portion of the neighbor. The second subscription may or may not tune from a serving RAT to perform the measurements.

### CROSS REFERENCE TO RELATED APPLICATION

This application claims the benefit under 35 U.S.C. §119(e) to U.S. Provisional Patent Application No. 62/146,168, entitled “SHARING MEASUREMENT RESOURCES WITHIN MULTI-RECEIVE MULTI-SIM USER EQUIPMENT,” filed on Apr. 10, 2015, the disclosure of which is expressly incorporated herein by reference in its entirety.

### BACKGROUND

1. Field

Aspects of the present disclosure relate generally to wireless communication systems, and more particularly, to an inter-radio access technology (IRAT) measurement method for a multi-receive multi-SIM (subscriber identity module) user equipment (UE).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a telecommunication standard is long term evolution (LTE). LTE is a set of enhancements to the universal mobile telecommunications system (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in wireless technology. Preferably, these improvements should be applicable to LTE and other multi-access technologies and the telecommunication standards that employ these technologies.

### SUMMARY

According to one aspect of the present disclosure, a method of wireless communication executes at a user equipment with a first subscription served by a first radio access technology (RAT) and a second subscription served by a second RAT, that differs from the first RAT. The method includes forwarding a second RAT neighbor cell list from the first subscription to the second subscription when preparing for measurement. The method also includes performing, by the second subscription, measurements of neighbors in the second RAT from the neighbor cell list. The method further includes forwarding the measurements of neighbors from the neighbor cell list, from the second subscription, to the first subscription.

According to another aspect of the present disclosure, an apparatus for wireless communication has a first subscription served by a first radio access technology (RAT) and a second subscription served by a second RAT, that differs from the first RAT. The apparatus includes a memory and at least one processor coupled to the memory. The processor(s) is configured to forward a second RAT neighbor cell list from the first subscription to the second subscription when preparing for measurement. The processor(s) is also configured to perform, by the second subscription, measurements of neighbors in the second RAT from the neighbor cell list. The processor(s) is further configured to forward the measurements of neighbors from the neighbor cell list, from the second subscription, to the first subscription.

According to another aspect of the present disclosure, a method of wireless communication executes at a user equipment with a first subscription and a second subscription, each supporting at least one radio access technology (RAT). The method includes forwarding a neighbor cell list from the first subscription to the second subscription when preparing for measurement. The method also includes performing, by the first subscription, measurements of a first portion of the neighbors from the neighbor cell list. The method also includes performing, by the second subscription, measurements of a second portion of neighbors from the neighbor cell list. The method further includes forwarding the measurements of neighbors from the neighbor cell list, from the second subscription, to the first subscription.

According to yet another aspect of the present disclosure, an apparatus for wireless communication has a first subscription and a second subscription. The apparatus includes a memory and at least one processor coupled to the memory. The processor(s) is configured to forward a neighbor cell list from the first subscription to the second subscription when preparing for measurement. The processor(s) is also configured to perform, by the first subscription, measurements of a first portion of the neighbors from the neighbor cell list. The processor(s) is also configured to perform, by the second subscription, measurements of a second portion of neighbors from the neighbor cell list. The processor(s) is further configured to forward the measurements of neighbors from the neighbor cell list, from the second subscription, to the first subscription.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in LTE.

FIG. 3 is a diagram illustrating an example of an uplink frame structure in LTE.

FIG. 4 is a block diagram conceptually illustrating an example of a telecommunications system.

FIG. 5 is a block diagram conceptually illustrating an example of a frame structure in a telecommunications system.

FIG. 6 is a block diagram illustrating an example of a global system for mobile communications (GSM) frame structure.

FIG. 7 is a block diagram conceptually illustrating an example of a base station in communication with a user equipment (UE) in a telecommunications system.

FIG. 8 is a diagram illustrating network coverage areas according to aspects of the present disclosure.

FIG. 9 is a flow diagram illustrating an example decision process for inter-RAT (IRAT) measurements at a multi-receive multi-SIM UE according to aspects of the present disclosure.

FIG. 10 is a flow diagram illustrating a method for IRAT measurements at a multi-receive multi-SIM UE according to aspects of the present disclosure.

FIG. 11 is a block diagram illustrating different modules/means/components for measurements at a UE in an example apparatus according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

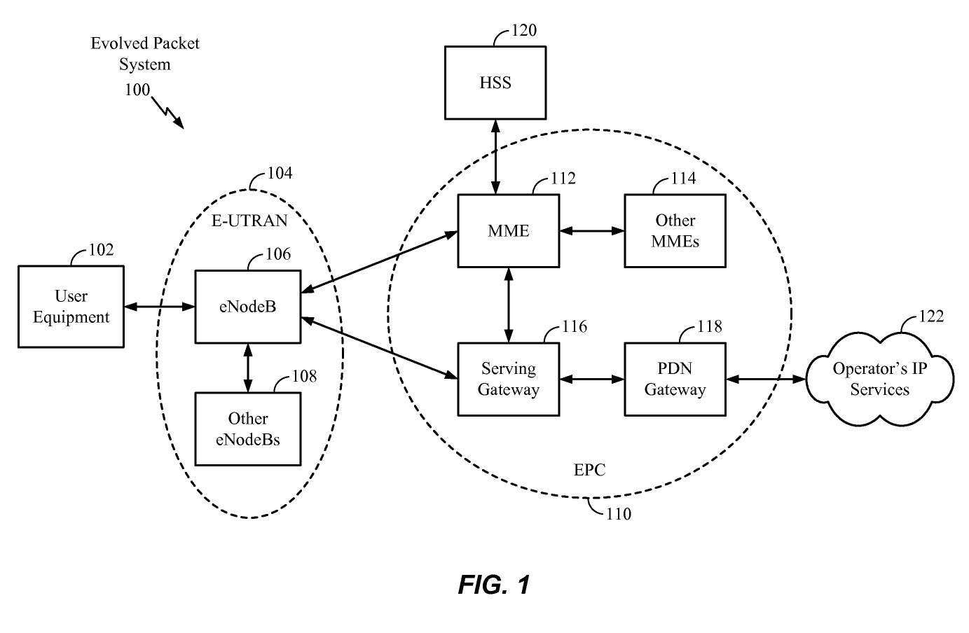

FIG. 1 is a diagram illustrating an LTE network architecture 100. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

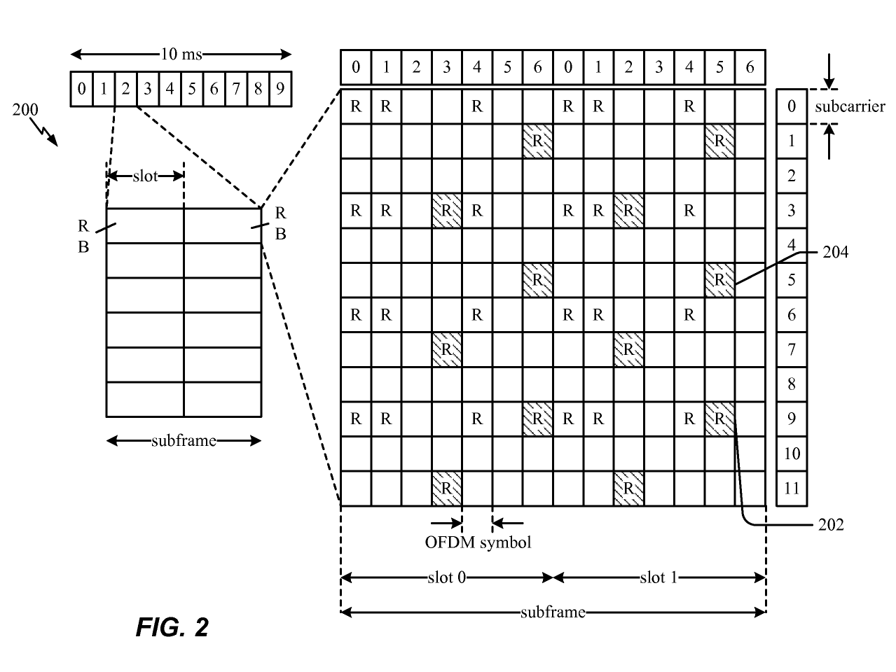

FIG. 2 is a diagram 200 illustrating an example of a downlink frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204. UE-RS 204 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

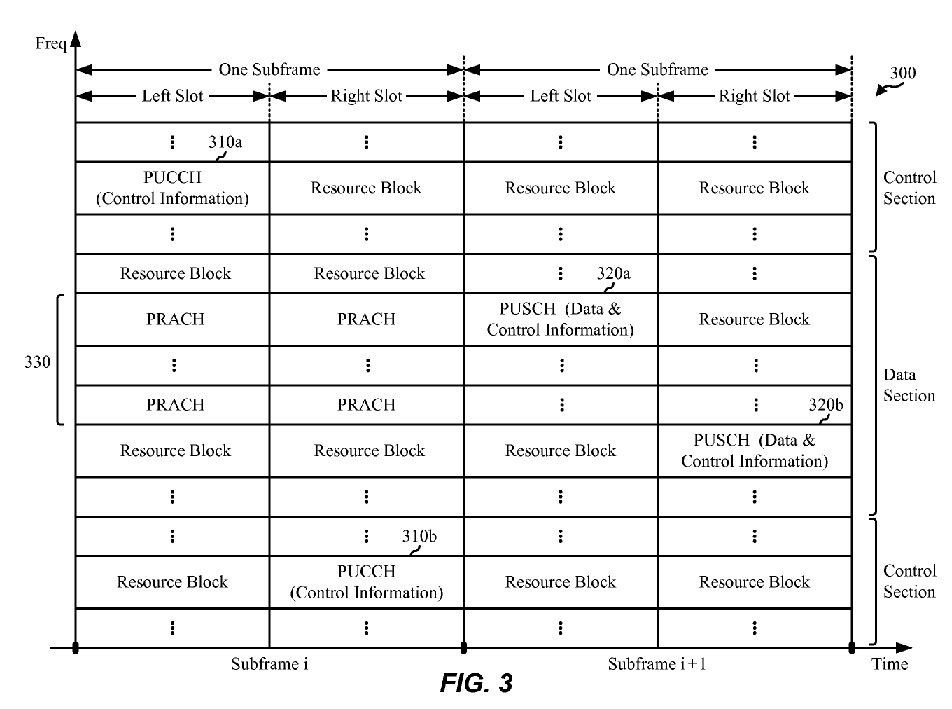

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 330. The PRACH 330 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

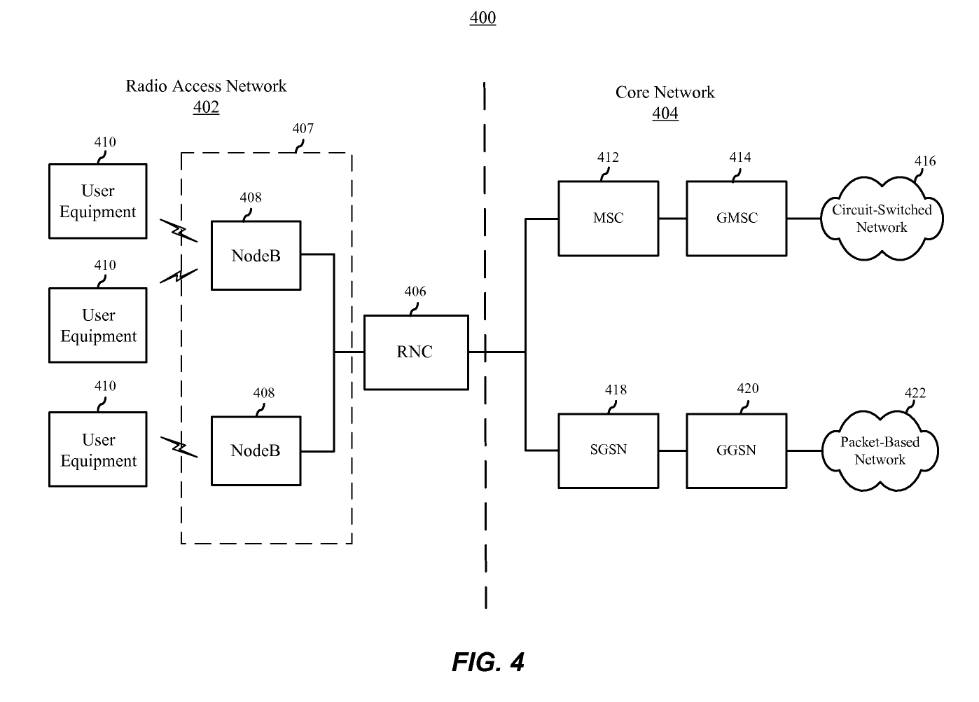

Turning now to FIG. 4, a block diagram is shown illustrating an example of a telecommunications system 400. The various concepts presented throughout this disclosure may be implemented across a broad variety of telecommunication systems, network architectures, and communication standards. By way of example and without limitation, the aspects of the present disclosure illustrated in FIG. 4 are presented with reference to a UMTS system employing a TD-SCDMA standard. In this example, the UMTS system includes a radio access network (RAN) 402 (e.g., UTRAN) that provides various wireless services including telephony, video, data, messaging, broadcasts, and/or other services. The RAN 402 may be divided into a number of radio network subsystems (RNSs) such as an RNS 407, each controlled by a radio network controller (RNC), such as an RNC 406. For clarity, only the RNC 406 and the RNS 407 are shown; however, the RAN 402 may include any number of RNCs and RNSs in addition to the RNC 406 and RNS 407. The RNC 406 is an apparatus responsible for, among other things, assigning, reconfiguring and releasing radio resources within the RNS 407. The RNC 406 may be interconnected to other RNCs (not shown) in the RAN 402 through various types of interfaces such as a direct physical connection, a virtual network, or the like, using any suitable transport network.

The geographic region covered by the RNS 407 may be divided into a number of cells, with a radio transceiver apparatus serving each cell. A radio transceiver apparatus is commonly referred to as a nodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two nodeBs 408 are shown; however, the RNS 407 may include any number of wireless nodeBs. The nodeBs 408 provide wireless access points to a core network 404 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 410 are shown in communication with the nodeBs 408. The downlink (DL), also called the forward link, refers to the communication link from a nodeB to a UE, and the uplink (UL), also called the reverse link, refers to the communication link from a UE to a nodeB.

The core network 404, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 404 supports circuit-switched services with a mobile switching center (MSC) 412 and a gateway MSC (GMSC) 414. One or more RNCs, such as the RNC 406, may be connected to the MSC 412. The MSC 412 is an apparatus that controls call setup, call routing, and UE mobility functions. The MSC 412 also includes a visitor location register (VLR) (not shown) that contains subscriber-related information for the duration that a UE is in the coverage area of the MSC 412. The GMSC 414 provides a gateway through the MSC 412 for the UE to access a circuit-switched network 416. The GMSC 414 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 414 queries the HLR to determine the UE's location and forwards the call to the particular MSC serving that location.

The core network 404 also supports packet-data services with a serving GPRS support node (SGSN) 418 and a gateway GPRS support node (GGSN) 420. General packet radio service (GPRS) is designed to provide packet-data services at speeds higher than those available with standard GSM circuit-switched data services. The GGSN 420 provides a connection for the RAN 402 to a packet-based network 422. The packet-based network 422 may be the Internet, a private data network, or some other suitable packet-based network. The primary function of the GGSN 420 is to provide the UEs 410 with packet-based network connectivity. Data packets are transferred between the GGSN 420 and the UEs 410 through the SGSN 418, which performs primarily the same functions in the packet-based domain as the MSC 412 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a nodeB 408 and a UE 410, but divides uplink and downlink transmissions into different time slots in the carrier.

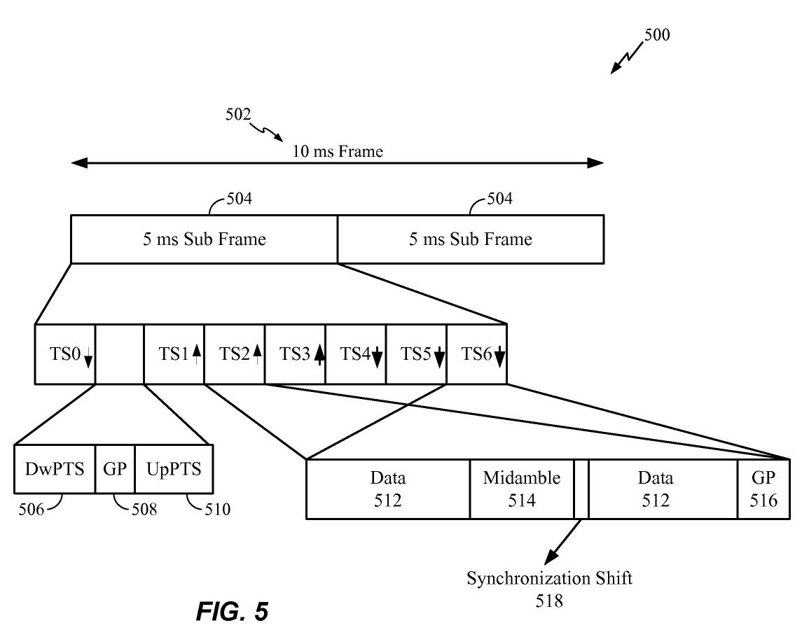

FIG. 5 shows a frame structure 500 for a TD-SCDMA carrier. The TD-SCDMA carrier, as illustrated, has a frame 502 that is 10 ms in length. The chip rate in TD-SCDMA is 1.28 Mcps. The frame 502 has two 5 ms subframes 504, and each of the subframes 504 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 506, a guard period (GP) 508, and an uplink pilot time slot (UpPTS) 510 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 512 (each with a length of 352 chips) separated by a midamble 514 (with a length of 144 chips) and followed by a guard period (GP) 516 (with a length of 16 chips). The midamble 514 may be used for features, such as channel estimation, while the guard period 516 may be used to avoid inter-burst interference. Also transmitted in the data portion is some Layer 1 control information, including synchronization shift (SS) bits 518. Synchronization Shift bits 518 only appear in the second part of the data portion. The synchronization shift bits 518 immediately following the midamble can indicate three cases: decrease shift, increase shift, or do nothing in the upload transmit timing. The positions of the synchronization shift bits 518 are not generally used during uplink communications.

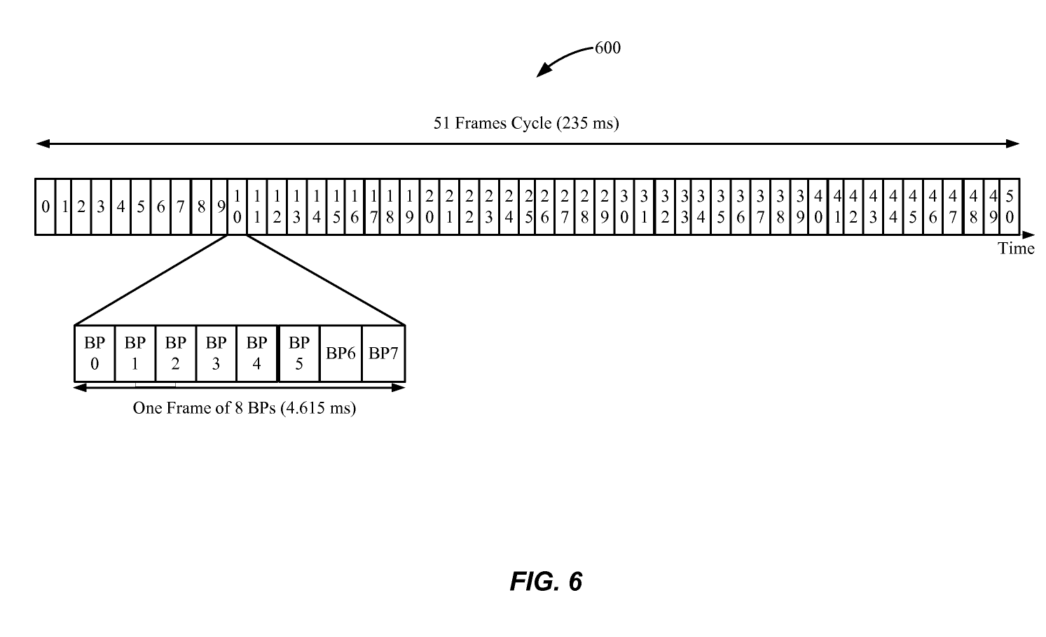

FIG. 6 is a block diagram illustrating an example of a GSM frame structure 600. The GSM frame structure 600 includes fifty-one frame cycles for a total duration of 235 ms. Each frame of the GSM frame structure 600 may have a frame length of 4.615 ms and may include eight burst periods, BP0-BP7.

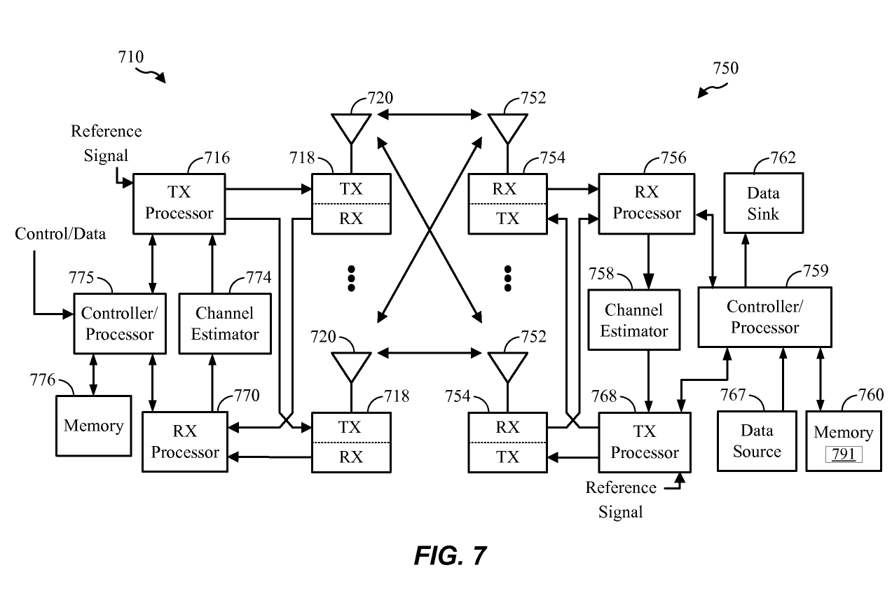

FIG. 7 is a block diagram of a base station (e.g., eNodeB or node B) 710 in communication with a UE 750 in an access network. In the downlink, upper layer packets from the core network are provided to a controller/processor 775. The controller/processor 775 implements the functionality of the L2 layer. In the downlink, the controller/processor 775 provides header compression, ciphering, packet segmentation and reordering, multiplexing between logical and transport channels, and radio resource allocations to the UE 750 based on various priority metrics. The controller/processor 775 is also responsible for HARQ operations, retransmission of lost packets, and signaling to the UE 750.

The TX processor 716 implements various signal processing functions for the L1 layer (i.e., physical layer). The signal processing functions includes coding and interleaving to facilitate forward error correction (FEC) at the UE 750 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 774 may be used to determine the coding and modulation scheme, as well as for spatial processing. The channel estimate may be derived from a reference signal and/or channel condition feedback transmitted by the UE 750. Each spatial stream is then provided to a different antenna 720 via a separate transmitter (TX) 718. Each transmitter (TX) 718 modulates a radio frequency (RF) carrier with a respective spatial stream for transmission.

At the UE 750, each receiver (RX) 754 receives a signal through its respective antenna 752. Each receiver (RX) 754 recovers information modulated onto an RF carrier and provides the information to the receiver (RX) processor 756. The RX processor 756 implements various signal processing functions of the L1 layer. The RX processor 756 performs spatial processing on the information to recover any spatial streams destined for the UE 750. If multiple spatial streams are destined for the UE 750, they may be combined by the RX processor 756 into a single OFDM symbol stream. The RX processor 756 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the base station 710. These soft decisions may be based on channel estimates computed by the channel estimator 758. The soft decisions are then decoded and deinterleaved to recover the data and control signals that were originally transmitted by the base station 710 on the physical channel. The data and control signals are then provided to the controller/processor 759.

The controller/processor 759 implements the L2 layer. The controller/processor can be associated with a memory 760 that stores program codes and data. The memory 760 may be referred to as a computer-readable medium. In the uplink, the controller/processor 759 provides demultiplexing between transport and logical channels, packet reassembly, deciphering, header decompression, control signal processing to recover upper layer packets from the core network. The upper layer packets are then provided to a data sink 762, which represents all the protocol layers above the L2 layer. Various control signals may also be provided to the data sink 762 for L3 processing. The controller/processor 759 is also responsible for error detection using an acknowledgement (ACK) and/or negative acknowledgement (NACK) protocol to support HARQ operations.

In the uplink, a data source 767 is used to provide upper layer packets to the controller/processor 759. The data source 767 represents all protocol layers above the L2 layer. Similar to the functionality described in connection with the downlink transmission by the base station 710, the controller/processor 759 implements the L2 layer for the user plane and the control plane by providing header compression, ciphering, packet segmentation and reordering, and multiplexing between logical and transport channels based on radio resource allocations by the base station 710. The controller/processor 759 is also responsible for HARQ operations, retransmission of lost packets, and signaling to the base station 710.

Channel estimates derived by a channel estimator 758 from a reference signal or feedback transmitted by the base station 710 may be used by the TX processor 768 to select the appropriate coding and modulation schemes, and to facilitate spatial processing. The spatial streams generated by the TX processor 768 are provided to different antenna 752 via separate transmitters (TX) 754. Each transmitter (TX) 754 modulates an RF carrier with a respective spatial stream for transmission.

The uplink transmission is processed at the base station 710 in a manner similar to that described in connection with the receiver function at the UE 750. Each receiver (RX) 718 receives a signal through its respective antenna 720. Each receiver (RX) 718 recovers information modulated onto an RF carrier and provides the information to a RX processor 770. The RX processor 770 may implement the L1 layer.

The controller/processor 775 implements the L2 layer. The controller/processors 775 and 759 can be associated with memories 776 and 760, respectively that store program codes and data. For example, the controller/processors 775 and 759 may provide various functions including timing, peripheral interfaces, voltage regulation, power management, and other control functions. The memories 776 and 760 may be referred to as a computer-readable media. For example, the memory 760 of the UE 750 may store an inter-SIM measurement module 791, which, when executed by the controller/processor 759, configures the UE 750 so that one subscription module performs measurements on behalf of another subscription module of a multi-receive multi-SIM UE.

In the uplink, the controller/processor 775 provides demultiplexing between transport and logical channels, packet reassembly, deciphering, header decompression, control signal processing to recover upper layer packets from the UE 750. Upper layer packets from the controller/processor 775 may be provided to the core network. The controller/processor 775 is also responsible for error detection using an ACK and/or NACK protocol to support HARQ operations.

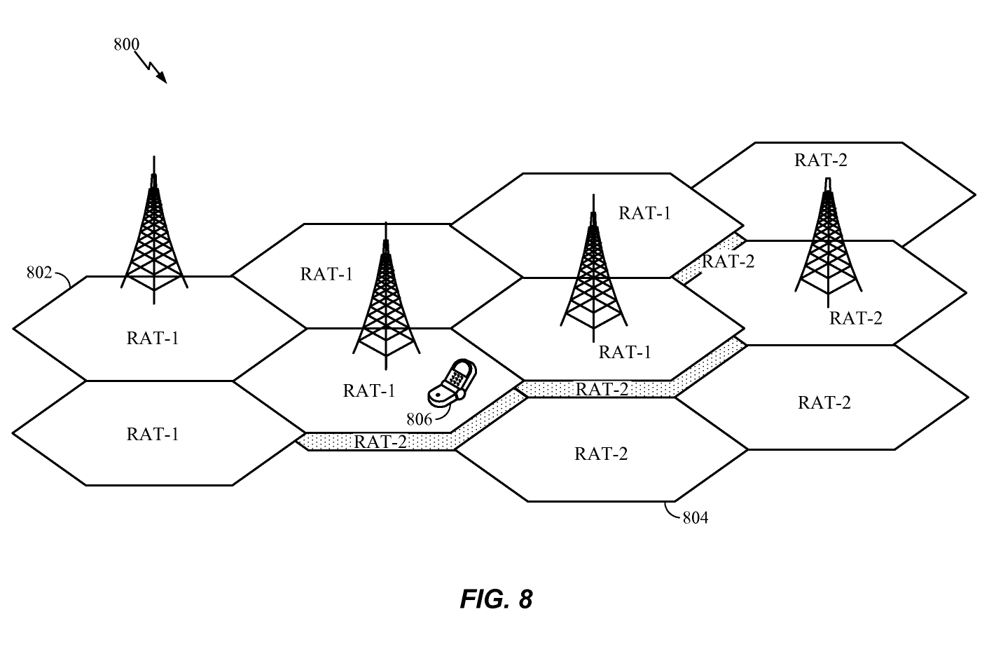

Some networks may be deployed with multiple radio access technologies. FIG. 8 illustrates a network utilizing multiple types of radio access technologies (RATs), such as but not limited to GSM (second generation (2G)), TD-SCDMA (third generation (3G)), LTE (fourth generation (4G)) and fifth generation (5G). Multiple RATs may be deployed in a network to increase capacity. Typically, 2G and 3G are configured with lower priority than 4G. Additionally, multiple frequencies within LTE (4G) may have equal or different priority configurations.

In one example, the geographical area 800 includes first RAT (RAT-1) cells 802 and second RAT (RAT-2) cells 804. In one example, the RAT-1 cells are 2G or 3G cells and the RAT-2 cells are LTE cells. However, those skilled in the art will appreciate that other types of radio access technologies may be utilized within the cells. A user equipment (UE) 806 may move from one cell, such as a RAT-1 cell 802, to another cell, such as a RAT-2 cell 804. The movement of the UE 806 may specify a handover or a cell reselection. The UE may also be redirected from a second RAT (RAT-2) to a different RAT (e.g., RAT-1) for a particular type of operation.

Redirection from one RAT to another RAT is commonly used to perform operations such as load balancing or circuit switched fallback from one RAT to another RAT. For example, one of the RATs may be long term evolution (LTE) while the other RAT may be universal mobile telecommunications system-frequency division duplexing (UMTS FDD), universal mobile telecommunications system-time division duplexing (UMTS TDD), or global system for mobile communications (GSM). In some aspects, the redirection may be from a frequency or cell of one RAT to a frequency or cell of the same RAT.

A handover or cell reselection may also be performed when there is a coverage hole or lack of coverage in one network or when there is traffic balancing between first RAT and the second RAT networks. As part of that handover or cell reselection process, while in a connected mode with a RAT-1 system, a UE may be specified to perform a measurement of a neighboring cell (such as a GSM cell). For example, the UE may measure the neighbor cells of a second network for signal strength, frequency channel, and base station identity code (BSIC). The UE may then connect to the strongest cell of the second network. Such measurement may be referred to as inter-radio access technology (IRAT) measurement.

The UE may send the serving RAT-1 cell a measurement report indicating results of the IRAT measurements performed by the UE. The serving cell may then trigger a handover of the UE to a new cell in the other RAT, such as the RAT-2 cell, based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

In one aspect of the present disclosure, the UE may be a multi-subscriber identity module (SIM) device and may perform measurements of neighbor cells of one or more RATs to facilitate the handover or reselection. For example, the UE may be a DR-DS dual-active (DA) device, which means each of the SIMs of the UE can connect to a network simultaneously. The UE may also be a dual-SIM dual-standby (DSDS) device, which means the UE is limited to connecting to one network at a time. For example, the UE is in an active state when the UE is connected to a network for a voice or data call. The UE, however, is in a standby state when the UE is not connected to the network for a voice or data call.

A user equipment (UE) may include more than one subscriber identity module (SIM) or universal subscriber identity module (USIM), which may also be termed subscription module. A UE with more than one SIM may be referred to as a multi-SIM device. In the present disclosure, a SIM may refer to a SIM or a USIM. Each SIM may also include a unique international mobile subscriber identity (IMSI) and service subscription information. Each SIM may be configured to operate in a particular radio access technology. Moreover, each SIM may have full phone features and be associated with a unique phone number. Therefore, the UE may use each SIM to send and receive phone calls independently. That is, the UE may simultaneously communicate via the phone numbers associated with each individual SIM. For example, a first SIM card can be associated for use in a City A and a second SIM card may be associated for use in a different City B to reduce roaming fees and long distance calling fees. Alternately, a first SIM card may be assigned for personal usage and a different SIM card may be assigned for work/business purposes. In another configuration, a first SIM card provides full phone features and a different SIM card is utilized mostly for data services.

Some multi-SIM devices support multi-SIM multi-standby operation using multiple radio frequency (RF) chains to transmit and receive communications. In one example, a multi-SIM device includes a first SIM dedicated to operate in a first radio access technology (RAT) and a second SIM dedicated to operate in a second RAT. In one illustrative example, the multi-SIM device includes a first SIM configured to operate in a fourth generation (4G) RAT (e.g., LTE) and a second SIM configured to operate in a second/third generation (2G/3G) RAT. The multi-SIM device may operate in other RATs known to those skilled in the art.

### Sharing Measurement Resources for a Multiple-Receive Multiple-SIM UE

Multi-receive (e.g., dual receive (DR)) is a feature that enables a user equipment (UE) to simultaneously receive data on two radio access technologies (RATs) that may be the same or different from each other. Dual-receive is different than dual-active in that there is only a single transmitter (Tx) for a DR UE.

An advantage of dual-receive is that it may allow the UE to avoid tune-away in certain scenarios to save energy and reduce latency. The dual-receive dual-SIM (DR-DS) UE may accommodate different RAT combinations such as LTE and GSM, WCDMA and GSM, TD-SCDMA and GSM, and 1×/DO and GSM, for example.

The current approach to inter-RAT (IRAT) measurements for a DR-DS UE may cause a large latency. For example, if the first subscription (Sub-1) is on TD-SCDMA and the second subscription (Sub-2) is on GSM, the UE may prepare and switch from the first TD-SCDMA cell to a GSM cell. The switchover process may include radio frequency (RF) script build up, firmware loading and booting up, and measurements themselves. The switchover process may be power consuming and time consuming.

It was observed that the UE performs IRAT monitoring and measurements in idle mode and connected mode, both in accordance with scheduling by the network. For reselection/handover to a 2 G/3 G cell, such as a GSM cell, the UE may complete the following steps on the target cell: measure receive signal strength indicator (RSSI); determine initial base station identity code (BSIC), and reconfirm the BSIC information.

While in the idle mode, the UE may have a bigger gap to perform IRAT measurements than in the connected mode. The gap size may vary depending upon the network call configurations. During an idle slot or gap, the UE may finish IRAT measurements as well as inter-frequency measurements. This may leave very little time to finish the above described switchover steps for all the neighbor cells during an idle gap.

Sometimes, even if the network allocates all the timeslots to the UE, the UE may still drop some time slots forcefully to make available gaps large enough for IRAT measurements in order to ensure a certain level of performance for services like a voice call and to avoid a call drop. In a situation like this, the UE may lose some data sent by the network on those slots dropped for the IRAT measurement.

It is proposed that for the multi-receive multi-SIM UE, one SIM module or subscription may be used to help the IRAT measurements of another SIM module or subscription. For example, assume a first subscription (Sub-1) is in a time division (TD)-LTE cell and a second subscription (Sub-2) is in a GSM cell. The multi-receive multi-SIM UE currently is in a packet-switched call on the LTE system with the first subscription and monitors for a page from the GSM cell with the other subscription.

When the Sub-1 performs IRAT measurements on GSM, it may request help from the Sub-2, which happens to be already in the GSM cell. The IRAT measurement can be requested from the Sub-2 especially when the Sub-2 is in an idle mode and may have longer gaps to schedule the IRAT measurements. Although this example is with respect to the Sub-2 being served by on a GSM cell and performing GSM measurements, the present disclosure also contemplates the Sub-2 being served by a GSM cell and switching to another RAT (e.g., WCDMA) to perform measurements in that other RAT (e.g., WCDMA).

The Sub-1 first shares its GSM/LTE neighbor cell list with the Sub-2. The Sub-2 may then schedule the requested measurements for the available idle gaps. The Sub-1 may start a timer for expected measurement results from the Sub-2. When the timer expires but the Sub-1 has not received the measurements from the Sub-2, the Sub-1 may schedule and perform the IRAT measurement itself, following the existing approach. In this case, the Sub-1 may assume that the Sub-2 has failed to complete the IRAT measurements for one reason or another. In another aspect of the present disclosure, the Sub-1 may also perform whatever measurements it can during its free gaps and request the Sub-2 to help perform IRAT measurements for the rest of the cells on the neighbor cell list.

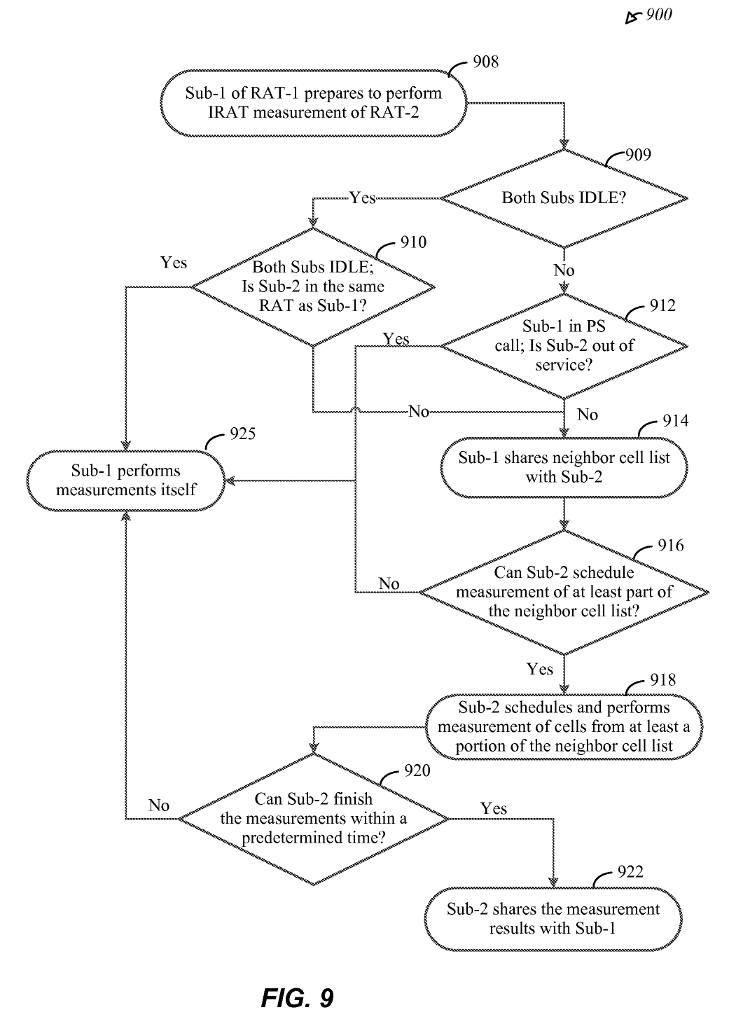

FIG. 9 shows a flow diagram 900 illustrating, as an example, a decision process for IRAT measurements at a multi-receive multi-SIM UE according to aspects of the present disclosure. The flow diagram 900 is for illustration purposes only and other alternative aspects of the decision process for the IRAT measurements are certainly possible.

At block 908, the first subscription (Sub-1) of the UE may have an occasion for an IRAT measurement. For example, the Sub-1 may be on a packet switched call on an LTE network and is paged for a voice call. It happens that the LTE network does not directly support voice call service and thus redirects the Sub-1 to a GSM network for a circuit-switch fall back (CSFB) voice call. To prepare for a switchover to a target GSM cell, the Sub-1 will perform IRAT measurements of neighbor GSM cells. In another example, the Sub-1 is in idle mode but will perform the IRAT measurements for one reason or another.

At block 909, the UE determines whether both subscriptions are in idle mode. If so, at block 910, the Sub-1 may determine whether the second subscription (Sub-2) is in the same RAT as itself This may be a part of the process for the Sub-1 to determine whether it can request the Sub-2 to help with the IRAT measurements. If the Sub-2 happens to be in the same RAT as the Sub-1, and both subscriptions are in idle mode, then there is not a clear advantage to ask the Sub-2 to help with at least part of the IRAT measurements of the neighbor cells of the second RAT, because the overhead of switchover to a different RAT for the Sub-2 is same as for the Sub-1.

At block 925, if both subscriptions are in idle mode and if the Sub-2 happens to be in the same RAT as the Sub-1, the Sub-1 follows the existing approach and goes through the process of switching over to the other RAT to perform IRAT measurements itself For example, if the Sub-1 and the Sub-2 are both in an LTE network, the Sub-1 switches to a GSM neighbor cell to perform IRAT measurements itself.

If the Sub-1 is on a packet switched call and the Sub-2 is in idle mode, at block 912, the Sub-1 checks whether the Sub-2 is out of service. If yes, the Sub-1 goes to block 925 and performs the IRAT measurements itself.

Otherwise, if the Sub-2 is not out of service, and also when both subscriptions are idle and on different RATs, the Sub-1 may share a neighbor cell list for the IRAT measurements, at block 914. In one example aspect of the present disclosure, the neighbor cell list may be a list of GSM absolute radio-frequency channel numbers (ARFCNs) that are included in the redirection command that the Sub-1 received from the LTE network when the Sub-1 is redirected to a 2 G/3 G cell for the voice call. That is, the Sub-1 may share neighbors corresponding to the RAT of the Sub-2 when both subscriptions are idle. If the Sub-1 is in a packet switched call, the Sub-2 may tune to a RAT that has a large number of neighbors in the neighbor list.

At block 916, the Sub-1 further determines whether the Sub-2 can schedule for the IRAT measurements. The Sub-2 may not be able to schedule for the IRAT measurements for the cells on the neighbor cell list for one reason or another. For example, the Sub-2 may be in a connected mode and the measurement gap may be too small to accommodate any IRAT measurement. In another example, the Sub-2 may be in a voice call and may not have a free gap to spare for the IRAT measurements for the Sub-1. If the Sub-2 cannot schedule for the IRAT measurements, the Sub-1 goes to block 925 and schedules and performs the IRAT measurements itself.

Otherwise, at block 918, the Sub-2 schedules and then performs the IRAT measurements on behalf of the Sub-1. The Sub-1 may schedule and perform the IRAT measurements for all or some of the cells on the neighbor cell list, depending on the length of the idle gap that the Sub-2 has available, the length and periodicity of the idle gap for the Sub-1, which RAT the Sub-2 is tuned to, and other factors. In one example aspect, the Sub-2 may schedule and perform IRAT measurements for a portion of neighbor cells while the Sub-1 can schedule and perform IRAT measurements for the remaining portion of neighbor cells.

At block 920, the Sub-1 may run a timer to measure how long to wait to receive the expected IRAT measurements from the Sub-2. If the timer expires before receiving the IRAT measurements, the Sub-1 may assume that the Sub-2 has failed to complete the IRAT measurements and the Sub-1 may perform the IRAT measurements itself at block 925.

If the Sub-2 can finish the IRAT measurements within the predetermined amount of time, at block 922, the Sub-2 may share the results of IRAT measurements with the Sub-1. The Sub-1, in turn, may report the IRAT measurements to the serving base station.

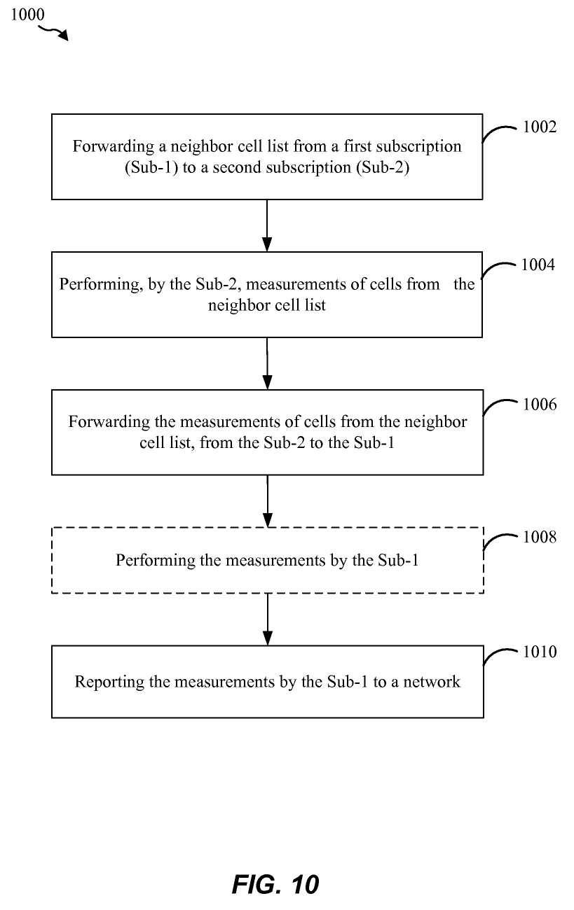

FIG. 10 is a flow diagram illustrating a method 1000 for IRAT measurements at a multi-receive multi-SIM UE, according to aspects of the present disclosure. At block 1002, the first subscription (Sub-1) of the multi-receive multi-SIM UE may forward a neighbor cell list to the second subscription (Sub-1) of the UE. This may happen when the Sub-1 is preparing for an IRAT measurement of a second RAT while the Sub-1 is currently in a first RAT. The Sub-1 may determine that the Sub-2 happens to be in the second RAT, in which case the neighbor cell list can be a list of neighbor cells in the second RAT. The IRAT measurements may be part of preparation for the Sub-1 to switch over to a target cell in the second RAT for a service such as circuit-switched fall back voice call.

In one example aspect of the present disclosure, the Sub-1 stays at the first RAT and Sub-2 stays at a second RAT cell to avoid the overhead associated with switching from one RAT to a different RAT by either subscription. This may also enable the UE to go to idle mode or sleep mode quickly and conserve battery power.

At block 1004, the Sub-2 of the UE performs the measurements as requested by the Sub-1. In one aspect of the present disclosure, the Sub-2 performs IRAT measurements for all cells on the neighbor cell list forwarded from the Sub-1. In another aspect of the present disclosure, the Sub-2 may perform measurements for only a portion of cells on the neighbor cell list in a load sharing mode with the Sub-1, based on a duration of free gaps available for measurement, other tasks the Sub-2 is engaged in at the moment, and other factors. For example, if the Sub-2 is in the idle mode with a large idle gap, the Sub-2 is more likely to perform the measurements for the entire neighbor cell list.

In one aspect of the present disclosure, the Sub-2 may perform IRAT measurements, intra-cell measurements, intra-frequency measurements, inter-frequency measurements, or any combination thereof In another aspect of the present disclosure, the Sub-2 may perform IRAT measurement of neighbor cells of a third RAT.

At block 1006, the Sub-2 may forward the results of the measurements it performed to the Sub-1. The forwarding of the measurement may be accomplished via an event triggered measurement report, an internal measurement report between the two subscription modules at the multi-receive multi-SIM UE or other ways of measurement reporting.

At block 1008, the Sub-1 may optionally perform measurements. This may occur in various situations. One situation is that the Sub-2 is in the same RAT as the Sub-1 while the Sub-1 is in idle mode. Another situation is the Sub-2 cannot schedule for the requested measurement because, for example, a free gap available for measurement by the Sub-2 is too small. In yet another situation, the Sub-2 is too busy or out of service to accommodate the IRAT measurements requested by the Sub-1. If the Sub-2 fails to complete the measurements within a predetermined time period, the Sub-1 may perform the measurement itself In another aspect of the present disclosure, the Sub-1 may perform the measurements itself for at least for a portion of the neighbor cell list in a load sharing mode with the Sub-2 when the Sub-2 can only perform the measurements for a portion of neighbor cell list. The Sub-2 may or may not already be in the RAT of the neighbor cells from the neighbor list.

In one aspect of the present disclosure, the multi-receive multi-SIM UE may determine an extent of load sharing for measurements between the Sub-1 and the Sub-2 based on a number of factors. For example, the UE may determine a first portion of the neighbors from the neighbor cell for measurement by the Sub-1 and a second portion of the neighbors from the neighbor cell for measurements by the Sub-2, based on a measurement gap periodicity and a measurement gap length of the Sub-1. The UE may also determine the first portion and the second portion, based on a measurement gap periodicity and a measurement gap length of the Sub-2. For example, if the measurement gap of the Sub-1 is sufficient for measurement of ten neighbor cells, but there are twenty neighbor cells to be measured, then the UE may send ten neighbors to the Sub-2 so the twenty neighbors can be finished together in one measurement gap. The UE can then go to the sleep mode after finishing measurements by both the Sub-1 and Sub-2.

At block 1010, the Sub-1 may also report the measurements it received from the Sub-2 and/or obtained by itself to the serving base station for the reselection of a neighbor GSM cell or handover to a different GSM base station.

Although the preceding example was with respect to IRAT measurements, the present disclosure is not so limited. That is, the other subscription could perform an inter-frequency measurement or intra-frequency measurement for the first subscription.

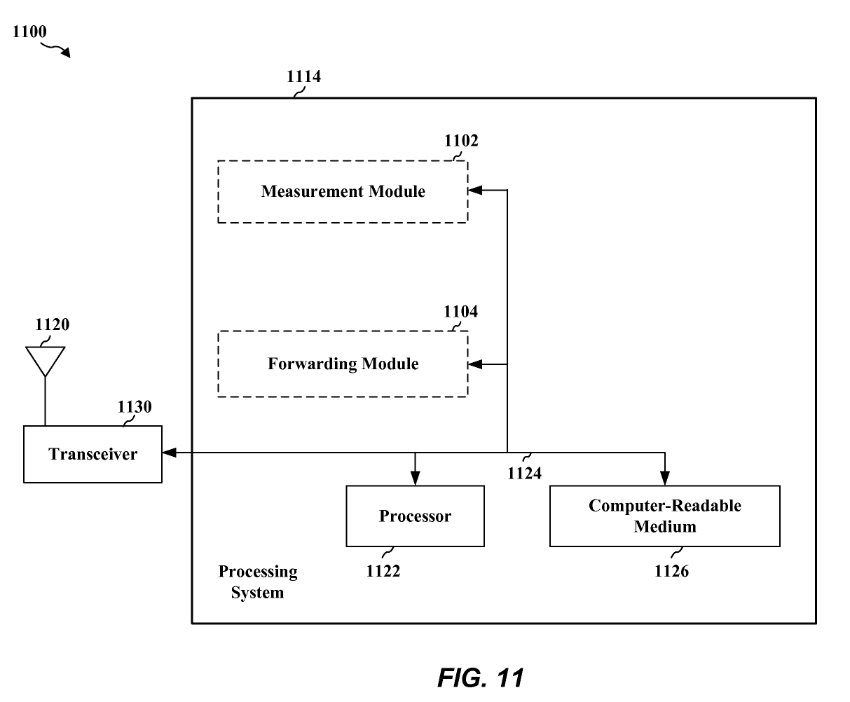

FIG. 11 is a block diagram illustrating an example of a hardware implementation for an apparatus 1100 employing a processing system 1114 with different modules/means/components for IRAT measurements in an example apparatus according to one aspect of the present disclosure. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1122 the modules 1102, 1104 and the non-transitory computer-readable medium 1126. The bus 1124 may also link various other circuits such as timing sources, peripherals, voltage regulators, and power management circuits, which are well known in the art, and therefore, will not be described any further.

The apparatus includes a processing system 1114 coupled to a transceiver 1130. The transceiver 1130 is coupled to one or more antennas 1120. The transceiver 1130 enables communicating with various other apparatus over a transmission medium. The processing system 1114 includes a processor 1122 coupled to a non-transitory computer-readable medium 1126. The processor 1122 is responsible for general processing, including the execution of software stored on the computer-readable medium 1126. The software, when executed by the processor 1122, causes the processing system 1114 to perform the various functions described for any particular apparatus. The computer-readable medium 1126 may also be used for storing data that is manipulated by the processor 1122 when executing software.

The processing system 1114 includes a measurement module 1102 for measuring signal qualities of cells included in a neighbor cell list. The measurement module 1102 may measure neighbor cells for a first SIM, a second SIM, additional SIMs or possibly even all SIMs. The processing system 1114 also includes a forwarding module 1104 for forwarding a neighbor cell list and measurements from one subscription module to another at a multi-SIM UE. The forwarding module 1104 also forwards measurement results among different SIMs. The modules 1102 and 1104 may be software modules running in the processor 1122, resident/stored in the computer-readable medium 1126, one or more hardware modules coupled to the processor 1122, or some combination thereof. The processing system 1114 may be a component of the UE 750 of FIG. 7 and may include the memory 760, and/or the controller/processor 759.

In one configuration, an apparatus such as a UE 750 is configured for wireless communication including means for forwarding a neighbor cell list from one subscription module to another subscription module at the UE. In one aspect, the forwarding means may include the controller/processor 759, the memory 760, the forwarding module 1104, and/or the processing system 1114 configured to perform the functions recited by the forwarding means. In one configuration, the means and functions correspond to the aforementioned structures. In another aspect, the aforementioned means may be any module or any apparatus configured to perform the functions recited by the forwarding means.

The UE 750 is also configured to include means for performing measurements by a subscription module, such as the first subscription and/or the second subscription as described above. In one aspect, the performing means may include the antennas 752, the receiver 754, the receive processor 756, the memory 760, the controller/processor 759, the measurement module 1102, and/or the processing system 1114 configured to perform the functions recited by the performing means. In one configuration, the means and functions correspond to the aforementioned structures. In another aspect, the aforementioned means may be any module or any apparatus configured to perform the functions recited by the performing means.

The UE 750 is also configured to include means for forwarding measurements from one subscription module to another subscription module at the UE. In one aspect, the forwarding means may include the controller/processor 759, the memory 760, the forwarding module 1104, and/or the processing system 1114 configured to perform the functions recited by the forwarding means. In one configuration, the means and functions correspond to the aforementioned structures. In another aspect, the aforementioned means may be any module or any apparatus configured to perform the functions recited by the forwarding means.

Several aspects of a telecommunications system has been presented with reference to LTE (in FDD, TDD, or both modes), and 2 G/3 G RATs such as GSM and TD-SCDMA. As those skilled in the art will readily appreciate, various aspects described throughout this disclosure may be extended to other telecommunication systems, network architectures and communication standards, including those with high throughput and low latency such as 4 G systems, 5 G systems and beyond. By way of example, various aspects may be extended to other systems such as LTE-advanced (LTE-A), W-CDMA, CDMA2000, evolution-data optimized (EV-DO), high speed downlink packet access (HSDPA), high speed uplink packet access (HSUPA), high speed packet access plus (HSPA+) and TD-CDMA. Various aspects may also be extended to systems employing ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one” of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication at a user equipment having a first subscription served by a first radio access technology (RAT) and a second subscription served by a second RAT, comprising:
forwarding a second RAT neighbor cell list from the first subscription to the second subscription when preparing for measurement, the second subscription served by the second RAT, which differs from the first RAT;
performing, by the second subscription, measurements of neighbors in the second RAT from the neighbor cell list; and
forwarding the measurements of neighbors from the neighbor cell list, from the second subscription, to the first subscription.

2. The method of claim 1, further comprising performing, by the first subscription, measurements of neighbors from the neighbor cell list when the second subscription does not forward the measurements within a predetermined time.

3. The method of claim 1, further comprising performing, by the first subscription, measurements of a first portion of the neighbors from the neighbor cell list.

4. The method of claim 3, further comprising performing, by the second subscription, measurements of a second portion of the neighbors from the neighbor cell list.

5. The method of claim 4, further comprising determining the first portion of the neighbors from the neighbor cell list for measurements by the first subscription and the second portion of the neighbors from the neighbor cell list for measurements by the second subscription, based at least in part on a first measurement gap periodicity and a first measurement gap length of the first subscription, and a second measurement gap periodicity and a second measurement gap length of the second subscription.

6. The method of claim 1, in which the measurements are at least one of an inter-RAT measurement, an intra-RAT measurement, an intra-frequency measurement, and an inter-frequency measurement.

7. The method of claim 1, further comprising performing, by the second subscription, measurements of neighbors from the neighbor cell list of the second RAT when the second subscription is in an idle mode and is camping on the second RAT.

8. The method of claim 1, further comprising performing, by the second subscription, measurements of at least one neighbor from the neighbor cell list of the second RAT when the second subscription has a free gap to schedule the measurements for at least portion of neighbors from the neighbor cell list.

9. The method of claim 1, further comprising reporting, by the first subscription, the measurements to a network.

10. An apparatus for wireless communication having a first subscription served by a first radio access technology (RAT) and a second subscription served by a second RAT, comprising:
a memory; and
at least one processor coupled to the memory and configured:
to forward a second RAT neighbor cell list from the first subscription to the second subscription when preparing for measurement, the second subscription served by the second RAT, which differs from the first RAT;
to perform, by the second subscription, measurements of neighbors in the second RAT from the neighbor cell list; and
to forward the measurements of neighbors from the neighbor cell list, from the second subscription, to the first subscription.

11. The apparatus of claim 10, in which the at least one processor is further configured to perform, by the first subscription, measurements of neighbors from the neighbor cell list when the second subscription does not forward the measurements within a predetermined time.

12. The apparatus of claim 10, in which the at least one processor is further configured to perform, by the first subscription, measurements of a first portion of the neighbors from the neighbor cell list.

13. The apparatus of claim 12, in which the at least one processor is further configured to determine the first portion of the neighbors from the neighbor cell list for measurements by the first subscription and a second portion of the neighbors from the neighbor cell list for measurements by the second subscription, based at least in part on a first measurement gap periodicity and a first measurement gap length of the first subscription, and a second measurement gap periodicity and a second measurement gap length of the second subscription.

14. The apparatus of claim 10, in which the measurements are at least one of an inter-RAT measurement, an intra-RAT measurement, an intra-frequency measurement, and an inter-frequency measurement.

15. The apparatus of claim 10, in which the at least one processor is further configured to perform, by the second subscription, measurements of neighbors from the neighbor cell list of the second RAT when the second subscription is in an idle mode and is camping on the second RAT.

16. The apparatus of claim 10, in which the at least one processor is further configured to perform, by the second subscription, measurements of at least one neighbor from the neighbor cell list of the second RAT when the second subscription has a free gap to schedule the measurements for at least portion of neighbors from the neighbor cell list.

17. A method of wireless communication at a user equipment with a first subscription and a second subscription, each supporting at least one radio access technology (RAT), comprising:
forwarding a neighbor cell list from the first subscription to the second subscription when preparing for measurement;
performing, by the first subscription, measurements of a first portion of the neighbors from the neighbor cell list;
performing, by the second subscription, measurements of a second portion of the neighbors from the neighbor cell list; and
forwarding the measurements of neighbors from the neighbor cell list, from the second subscription, to the first subscription.

18. The method of claim 17, further comprising performing, by the first subscription, measurements of neighbors from the neighbor cell list when the second subscription does not forward the measurements within a predetermined time.

19. The method of claim 17, further comprising determining the first portion of the neighbors from the neighbor cell list for measurements by the first subscription and the second portion of the neighbors from the neighbor cell list for measurements by the second subscription, based at least in part on a first measurement gap periodicity and a first measurement gap length of the first subscription, and a second measurement gap periodicity and a second measurement gap length of the second subscription.

20. The method of claim 17, in which the measurements are at least one of an inter-RAT measurement, an intra-RAT measurement, an intra-frequency measurement, and an inter-frequency measurement.

21. The method of claim 17, further comprising performing, by the second subscription, measurements of neighbors from the neighbor cell list of a first RAT when the second subscription is in an idle mode and is camping on the first RAT.

22. The method of claim 17, further comprising performing, by the second subscription, measurements of neighbors from the neighbor cell list of a second RAT when the second subscription is in an idle mode and is camping on a first RAT.

23. An apparatus for wireless communication having a first subscription and a second subscription, comprising:
a memory; and
at least one processor coupled to the memory and configured:
to forward a neighbor cell list from the first subscription to the second subscription when preparing for measurement;
to perform, by the first subscription, measurements of a first portion of the neighbors from the neighbor cell list;
to perform, by the second subscription, measurements of a second portion of the neighbors from the neighbor cell list; and
to forward the measurements of neighbors from the neighbor cell list, from the second subscription, to the first subscription.

24. The apparatus of claim 23, in which the at least one processor is further configured to perform, by the first subscription, measurements of all neighbors from the neighbor cell list when the second subscription does not forward the measurements within a predetermined time.

25. The apparatus of claim 23, in which the at least one processor is further configured to determine the first portion of the neighbors from the neighbor cell list for measurements by the first subscription and the second portion of the neighbors from the neighbor cell list for measurements by the second subscription, based at least in part on a first measurement gap periodicity and a first measurement gap length of the first subscription, and a second measurement gap periodicity and a second measurement gap length of the second subscription.

26. The apparatus of claim 23, in which the measurements are at least one of an inter-RAT measurement, an intra-RAT measurement, an intra-frequency measurement, and an inter-frequency measurement.

27. The apparatus of claim 23, in which the at least one processor is further configured to perform, by the second subscription, measurements of neighbors from the neighbor cell list of a first RAT when the second subscription is in an idle mode and is camping on the first RAT.

28. The apparatus of claim 23, in which the at least one processor is further configured to perform, by the second subscription, measurements of neighbors from the neighbor cell list of a second RAT when the second subscription is in an idle mode and is camping on a first RAT.
